(19) United States
(12) Patent Application Publication
(10) Pub. No.: US 2026/0135690 A1
(43) Pub. Date: May 14, 2026

(54) SYSTEMS AND METHODS FOR SECURE GENERATION, TRANSMISSION, AND MANAGEMENT OF DIGITAL CONTENT DATA

(71) Applicant: Skillz Platform Inc., Las Vegas, NV (US)

(72) Inventors: Thomas Fallon, Las Vegas, NV (US); Mehul Mittal, Foster City, CA (US); Sergio Andres Arboleda Cardona, El Poblado (CO); Suhas Chikkanaravangala Vijaykumar, Las Vegas, NV (US); Bartlomiej Krok, Warsaw (PL); Tomasz Janiczek, Las Vegas, NV (US); Brook Boese, Portland, OR (US); Nidhi Gupta, Las Vegas, NV (US)

(21) Appl. No.: 19/296,558

(22) Filed: Aug. 11, 2025

Related U.S. Application Data
(60) Provisional application No. 63/682,087, filed on Aug. 12, 2024.
(60) Provisional application No. 63/682,094, filed on Aug. 12, 2024.

(51) Int. Cl. H04L 9/06

(52) U.S. Cl. CPC H04L 9/0631

(57) ABSTRACT

Systems and methods for encrypting a score are provided. The method comprises generating, by a processor executing compiled instructions, a score representing a result of an interactive digital instance operating on a web-browser executing on the processor, the interactive digital instance operating on the web-browser using the compiled instructions and a software development kit (SDK), receiving, by the interactive digital instance operating on the web-browser, an input for submitting the score representing the result of the interactive digital instance, accessing, by the compiled instructions executed by the processor, one or more additional instructions included as part of the SDK for encrypting the score responsive to the input, encrypting, by the processor, the score using one or more additional instructions included as part of the SDK, and transmitting the score that is encrypted, by the processor, to a device that is separate from and external to the processor.

### CROSS-REFERENCE TO RELATED APPLICATIONS

This application claims the benefit of U.S. Provisional Application No. 63/682,087, filed on Aug. 12, 2024, and U.S. Provisional Application No. 63/682,094, filed on Aug. 12, 2024, the entire contents of each of which are hereby incorporated by reference herein.

### TECHNICAL FIELD

The subject matter described herein relates to digital content rendering and displaying and for securely generating data and sharing data across various devices and various device specific user interfaces and platforms.

### SUMMARY

In aspects, a method implemented by at least one data processor is provided. In aspects, a score representing a result of an interactive digital instance operating on a web-browser executing on the at least one data processor can be generated. In aspects, the interactive digital instance operating on the web-browser can use the compiled instructions and a software development kit (SDK). In aspects, an input for submitting the score representing the result of the interactive digital instance can be received and one or more additional instructions included as part of the SDK for encrypting the score responsive to the input can be accessed. In aspects, the score can be encrypted using the one or more additional instructions, wherein the score is encrypted using a bitwise shifting operation in a first direction on the unencrypted data representing the score. In aspects, the encrypted score can be transmitted to a device that is separate from and external to the at least one data processor.

One or more of the following features can be included in any feasible combination. For example, in aspects, a process for generating the compiled instructions occurs in the device that can be separate from and external to the at least one data processor. In aspects, the input for submitting the score can be received by selecting an interactive icon output on a digital page of the interactive digital instance operating on the web-browser. In aspects, the encrypting of the score can be based on an Advanced Encryption Standard (AES) algorithm. In aspects, the method implemented by the at least one processor can further comprise a salt hashing operation that can be implemented on the unencrypted data upon which the bitwise shifting operation is performed. In aspects, the method implemented by the at least one processor can further comprise storing, in memory, the encrypted data upon which the bitwise shifting operation is performed and the salt hashing operation is implemented.

In aspects, the encrypting of the score using the one or more additional instructions included as part of the SDK can comprise performing, by the at least one data processor, an additional bitwise shifting operation on the unencrypted data in a second direction and extracting, by the at least on data processor, the unencrypted data. In aspects, the method further comprises executing an asymmetric encryption algorithm. In aspects, the asymmetric encryption algorithm can be represented by one or more additional instructions of the SDK on the unencrypted data that is extracted. In aspects, the method can further comprise executing a symmetric encryption algorithm. The symmetric encryption algorithm can be represented by the one or more additional instructions of the SDK on the unencrypted data that is extracted.

In another aspect, a system comprising at least one data processor and memory storing instructions is contemplated. The instructions, when executed by the at least one data processor, can cause the at least one data processor to perform operations comprising generating, a score representing a result of an interactive digital instance operating on a web-browser, the interactive digital instance operating on the web-browser using the compiled instructions and a SDK, receiving, an input for submitting the score representing the result of the interactive digital instance, accessing one or more additional instructions included as part of the SDK for encrypting the score responsive to the input, encrypting the score using the one or more additional instructions, wherein the score is encrypted using a bitwise shifting operation in a first direction on the unencrypted data representing the score, and transmitting the score that is encrypted to a device that is separate from and external to the at least one data processor.

In yet another aspect, a non-transitory computer readable storage media storing instructions can be provided. Execution of the instructions can cause the at least one data processor to perform operation operations comprising generating a score representing a result of an interactive digital instance operating on a web-browser, the interactive digital instance operating on the web-browser using the compiled instructions and a SDK, receiving, by the interactive digital instance operating on the web-browser, an input for submitting the score representing the result of the interactive digital instance, accessing one or more additional instructions included as part of the SDK for encrypting the score responsive to the input, encrypting the score using one or additional instructions included as part of the SDK, and transmitting the score that is encrypted to a device that is separate from and external to the at least one data processor.

In another aspect, a method implemented by at least one data processor is provided. In aspects, a digital page of an interactive digital instance operation on a web-browser can be displayed by at least one data processor. In aspects, the digital page can include digital content including at least one user selectable icon, the interactive digital instance operating on the web-browser using the compiled instructions and a software development kit (SDK). In aspects, additional digital content can be loaded automatically upon displaying the digital page, by the at least one data processor, the additional digital content in association with an iFrame included as part of one or more instructions of the SDK. In aspects, the loading of the additional digital content in association with iFrame can be monitored by the at least one data processor. In aspects, a command to initiate a match within the interactive digital instance can be received by the at least one data processor, the command generated by a user interaction with the interactive digital instance. In aspects, an additional digital page of the at least one of the plurality of digital games can be displayed approximately in real time by the at least one data processor subsequent to receiving the input to initiate the match.

One or more of the following features can be included in any feasible combination. For example, in aspects, the interactive digital instance can correspond to a digital game operating on the web-browser. In aspects, the receiving of the input to initiate the match within the interactive digital instance can include selecting an interactive icon for starting the match between two or more users of the interactive digital instance.

In aspects, implementation of a process for generating the compiled instructions can occur in an additional device that is separate from and external to the at least one data processor. In aspects, the loading of the additional digital content of the at least one of the plurality of digital games in association with the iFrame can comprise extracting the additional digital content of the at least one of the plurality of digital games from a content delivery network (CDN). In aspects, the additional digital page of the at least one of the plurality of digital games can include at least some of the additional digital content of the at least one of the plurality of digital games.

In aspects, a score representing a result of the match can be generated. In aspects, an additional input for submitting the score representing the result of the interactive digital instance can be received. In aspects, one or more additional instructions included as part of the SDK for encrypting the score responsive to the input can be initiated. In aspects, the score can be encrypted using one or additional instructions included as part of the SDK. In aspects, the encrypted score can be transmitted to a device that is separate from and external to the at least one data processor. In aspects, the additional digital page of the at least one of the plurality of digital games can include at least some of the additional digital content of the at least one of the plurality of digital games.

In aspects, the at least one data processor can maintain an active session for each digital page. In aspects, the performance of the active session on each digital page can be monitored. In aspects, the digital page can automatically transition upon detecting a decrease in the performance of the active session on the additional digital page. In aspects, the active session on the additional digital page can be restarted while displaying the digital page.

In another aspect, a system including at least one data processor included as part of a computing device and memory storing instructions is provided. In aspects, the instructions stored in memory, when executed by the at least one data processor, can cause the at least one data processor to perform operations comprising displaying a digital page of an interactive digital instance operating on a web-browser, the digital page including digital content including at least one user selectable icon, the interactive digital instance operating on the web-browser using the compiled instructions and a software development kit, loading automatically upon the displaying of the digital page, additional digital content of at least one of a plurality of digital games in association with an iFrame included as part of one or more instructions of the SDK, monitoring, the loading of the additional digital content of the at least one of the plurality of digital games in association with the iFrame, receiving a command to initiate a match within the interactive digital instance, the command generated by a user interaction with the interactive digital instance, and displaying an additional digital page of the at least one of the plurality of digital games approximately in real time subsequent to the receiving of the input to initiate the match.

In yet another aspect, a non-transitory computer program product storing instructions executable by at least one data processor is provided. The instructions, when executed by the at least one data processor causes the at least one data processor to perform operations comprising: displaying a digital page of an interactive digital instance operating on a web-browser, the digital page including digital content including at least one user selectable icon, the interactive digital instance operating on the web-browser using the compiled instructions and a software development kit, loading automatically upon the displaying of the digital page, additional digital content of at least one of a plurality of digital games in association with an iFrame included as part of one or more instructions of the SDK, monitoring the loading of the additional digital content of the at least one of the plurality of digital games in association with the iFrame, receiving a command to initiate a match within the interactive digital instance, the command generated by a user interaction with the interactive digital instance, and displaying an additional digital page of the at least one of the plurality of digital games approximately in real time subsequent to the receiving of the input to initiate the match.

### BRIEF DESCRIPTION OF THE FIGURES

FIG. 1 depicts a block diagram of a computing environment in which the data management system of the present disclosure can be implemented, according to some aspects described and illustrated herein;

FIG. 2 depicts digital representations of different digital pages of end user client application instances, according to some aspects described and illustrated herein;

FIG. 3A depicts an example framework of a web application comprising a plurality of digital layers and instructions that enable operation of the end user client application instance on the client device, according to some aspects described and illustrated herein;

FIG. 3B depicts another example framework of a web application comprising a plurality of digital layers and instructions that enable operation of the end user client application instance on the client device, according to some aspects described and illustrated herein;

FIG. 4 depicts several example representations of different digital pages of a multicade platform that enable operation of the end user client application instance on the client device, according to some aspects described and illustrated herein;

FIG. 5 depicts a step of storing instructions usable for implementation of mobile application implementation instructions and web application implementation instructions in a common memory location (e.g., a code repository), according to some aspects described and illustrated herein;

FIG. 6 depicts a flow chart for securely generating data and sharing data among the various devices included as part of the data management system of the present disclosure, according to some aspects described and illustrated herein;

FIG. 7 depicts an example digital page of an end user client application instance, according to some aspects described and illustrated herein;

FIG. 8A depicts an implementation of an encryption algorithm for encrypting a generated score, according to some aspects described and illustrated herein;

FIG. 8B depicts an example transmission of the encrypted score to the back end of the data management system, according to some aspects described and illustrated herein;

FIG. 8C depicts another example transmission of the encrypted score to the back end of the data management system, according to some aspects described and illustrated herein;

FIG. 9 depicts an example multicade system that incorporates aspects of the example transmission of the encrypted score to the back end of the data management system, according to some aspects described and illustrated herein;

FIG. 10 depicts a flow chart for implementing a process for efficient rendering and displaying of digital content in the end user client application instance operating on the client device, according to some aspects described and illustrated herein;

FIG. 11 depicts a use case of the implementation of the process illustrated in FIG. 10; and

FIG. 12 depicts a block diagram of an example computing device that may perform one or more of the operations described in the present disclosure, according to some aspects described and illustrated herein.

### DETAILED DESCRIPTION

Digital content, such as digital games, are readily accessible via different platforms operable on various devices having different device capabilities and functionalities. The software applications that enable operation of instances of these digital games on these devices vary significantly in terms of computational efficiency, accuracy, complexity, and so forth. Additionally, with an increase in the sophistication of gamers, instances of fraudulent conduct related to competitive gaming has skyrocketed. Use of unauthorized software in the form of aimbots and spyware, hardware that enables macro commands (e.g., short sequences of keystrokes), cheat codes, lag switches, account hacking, and so forth, are all examples of ways in which users can cheat and/or gain an unfair advantage in digital games. Moreover, another cheating technique pertains to unauthorized and fraudulent modification of a score of a digital game. For example, users may route the web-browser on which the gaming instance operates through, e.g., a proxy (e.g., proxy server), which can be used to edit the contents of the web-browser (e.g., HTML data), including data representing a score of an outcome of a completed match between two gamers. Further, users today also expect more seamless interactive gaming experience. Due to the variety and complexity of digital games currently available, gamers expect reduced page loading times, near real-time feedback, constant access to various platforms (e.g., no downtime), and so forth. In some cases, gamers expect this seamless experience—including access to a vast catalog of digital games—to be delivered through a single, unified platform, rather than fragmented across multiple ecosystems (e.g., Stream, Origin, mobile app stores) that require separate downloads and third-party launchers to host and run each title.

The approach described in the present disclosure addresses at least some of these deficiencies. For example, this approach can include a data management system that can implement a robust set of steps that prevent fraudulent modification of a score representing an outcome of a digital game, e.g., a digital game that is hosted on and accessible via a web browser. The data management system can enable operation of instances of the digital game on a large number of devices (e.g., approximately in real time and simultaneously across hundreds or thousands of devices). Moreover, each of these instances can be accessible via respective web browsers operating simultaneously on these devices.

These web browsers, in part, can control operation of instances of these digital games using web assembly instructions, which include a set of game instructions that are compiled in servers that are separate from and external to the devices on which these browsers operate. An exemplary advantage of controlling the gaming instances using compiled game instructions is that these instructions are suitable for execution by a machine (e.g., are in binary form), and as such, cannot be interpreted, analyzed, and readily deciphered by a human. Further, as these instructions are compiled in a server that is separate and distinct from the user's device, a user is prevented from accessing the source code (code that can be interpreted by a human) utilized to generate the compiled code. As such, manipulation of scores generated using these compiled instructions can be prevented at least because (1) humans cannot interpret and/or decipher them, and (2) a proxy server may not be able to access the source code used to generate these scores.

Another exemplary advantage of the data management system of the present disclosure is that the system can store a bitwise shifted version of a score locally in memory of a device in which the digital game is accessed. Further, a salt or a salt and hash based algorithm can be implemented relative to the bitwise shifted version of the score such that data representing the score can be stored in a column of a table in association with the multi-character string (salt) specific to the score and/or another multi-character string generated as a result of implementation of a hashing algorithm. The use of the salt and/or salt and hash-based algorithm can provide an additional advantage in that it can provide an additional layer of security for the score. Finally, the web assembly instructions can implement a set of encryption techniques to prevent access to the content of a generated score (e.g. the numeric version of the score). In an example aspect, upon selection of a request to transmit a score (e.g., initiated by a user selecting an interactive icon labeled “submit score”), the compiled instructions included in the web assembly instructions retrieve a numeric version of the score by (1) performing another bitwise shifting operation, (2) utilizing the multi-character string (salt) dedicated for the score (without revealing the salt to the user of the web browser), and (3) encrypting the numeric version of the score before transmitting the score to servers external to the device on which web browser operates and on which an instance of the digital game is displayed. The encryption technique hides the generated score from the user's view and from the view of, e.g., a proxy server that may be utilized to fraudulently manipulate the score. In particular, using a proxy server may not allow access to the score because the instructions utilized to implement the encryption are compiled instructions (machine readable only) and the type of encryption algorithm that is used is unknown to the user and/or the proxy server, which can prevent the proxy server from decrypting the generated score.

Another exemplary advantage of the data management system of the present disclosure is that it can utilize an iFrame (“inline frame”) to monitor, in real time, loading of an amount of digital content of a digital game while a particular user is interacting with various aspects of the web application (e.g., aspects of a digital page of the digital game operating on the web browser). An iFrame can be defined as an element (e.g., an instruction in the form of software code) that operates to access and load digital content from a location external to the location of the iFrame in order enable rendering and displaying of the loaded digital content on a particular digital page. When a threshold amount of digital content has been loaded, the data management system can enable a near-seamless and approximately real-time transition from one digital page of the digital game to another. Further, the data management system can enable such an approximately real-time digital page transition across hundreds or thousands of instances of the digital game operating on hundreds or thousands of web browsers operating simultaneously on hundreds and thousands of devices. The phrase “real time” can relate to an action that is implemented, e.g., rendering and displaying of a digital page that includes various types of interactive digital content (text, animations, graphical user interfaces, etc.), response to and within a few seconds (e.g., 1-3 seconds) or microseconds (e.g., 2-5 microseconds) of another action.

In some instances, aspects of the data management system can operate as part of a larger multi-game arcade (multicade) platform. For example, the multicade platform can host a variety of digital games (e.g., arcade games, competitive multiplayer games, single-player experiences) within a unified web application environment. Each digital game within the multicade platform can be independently accessed and played using the multicade web application, which can provide a centralized location for users to interact, engage, and compete in various digital gaming events. The data management system, operating as part of the multicade platform, can prevent fraudulent modification of scores representing outcomes of various digital games hosted on the platform.

Additionally, the data management system can provide centralized control, analytics, and fraud protection mechanisms over the entire catalog of digital games on the multicade platform. For example, the data management system can securely transmit and verify the outcomes of digital games from a large number of devices running the multicade platform. Moreover, each of these instances can be monitored and managed using the data management system to prevent fraudulent activities or transactions.

Further, the multicade platform can simplify user access to digital games by providing a centralized game catalog. This can eliminate the need for users to download individual game applications and launchers to host and run each digital game, which can save memory space and simplify device resource management. As such, users are not required to allocate additional storage for each standalone title or maintain multiple background processes associated with various third-party game managers. Additionally, this approach can eliminate the need for separate app store submissions, updates, and compliance processes for each individual game title. Rather, new games can be introduced and maintained within the existing multicade web framework, which can streamline deployment and reduce overhead.

This approach can also eliminate the need to download external anti-fraud or cheating software, such as external client-side applications or kernel-mode drivers. Rather, by integrating the data management system into the multicade platform, this approach can reduce the computational overhead and memory constraints on the system by reducing redundant processing on client devices. Further, this tightly coupled approach can streamline enforcement of competitive integrity, enabling real-time score validation, session tracking, and fraud detection within a unified platform.

The centralized environment of the multicade platform can also increase user engagement. New and existing users are more likely to find games that align with their individual skills or preferences, leading to increased engagement and a higher likelihood of monetization while users remain engaged on the platform. Further, the platform can increase user acquisition by promoting specific tournaments or events (such as tournaments spanning multiple games or matches) to users.

The platform can further improve user retention by including personalized responses and engagement mechanisms, such as customized game recommendations, featured tournaments, game switching options, and real-time notifications. For example, based on a player's performance across multiple games, the platform can provide notifications to encourage users to enter into tournaments or suggest limited-time entries to increase user interactions with the platform.

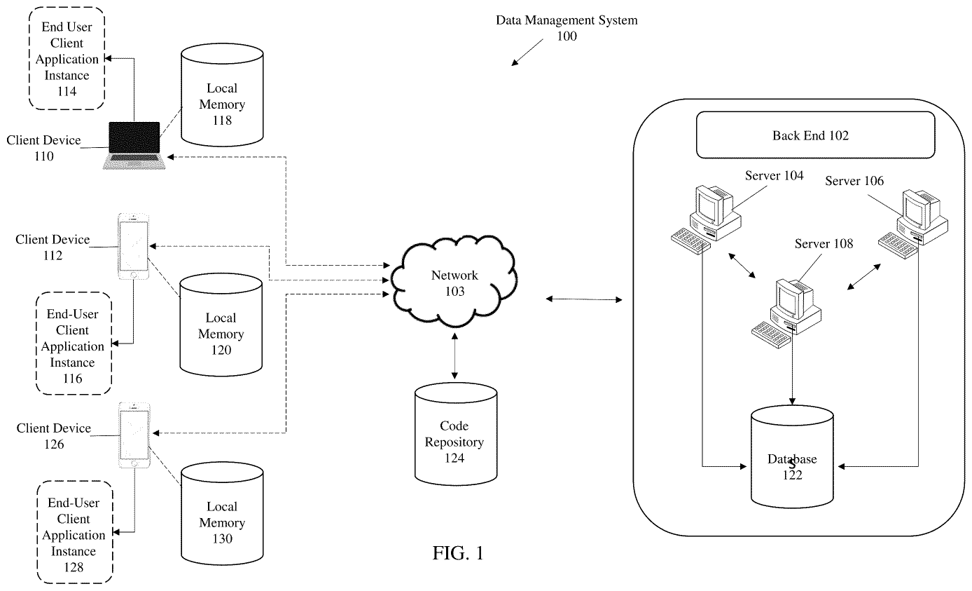

FIG. 1 depicts a block diagram of a computing environment in which the data management system 100 of the present disclosure can be implemented, according to some aspects described and illustrated herein. In aspects, the computing environment can include a back end 102, which refers to and can include a combination of servers (e.g., servers 104, 106, and 108) communicatively coupled to one another (via a network 103) and through a wired or wireless connection and to one or more devices external to the back end 102. In aspects, the servers 104, 106, and 108 can be communicatively coupled to one another as part of an intranet, internet, a distributed network, and so forth. The servers 104, 106, and 108 can share data with each other in addition to storing data locally as part of physical hardware (e.g., memory) included in these devices. Further, the servers 104, 106, and 108 can store and execute instructions that enable implementation of and control over operation of respective instances of an end user client application (end user client application instances 114, 116, 128). The client devices 110, 112, and 126 can include, e.g., a laptop computer, a tablet computer, a smartphone, a desktop or personal computer, game consoles, and other such comparable devices.

In aspects, the end user client application can be a software application in the form of a digital skills-based game in which users compete against a non-human opponent, e.g., an algorithm operating as part of the software application that analyzes and counters a human user's moves within the game. Alternatively, the end user client application can be a software application in the form of an asynchronous skills-based game or a synchronous skills-based game. In the asynchronous competitive skills-based game, players can compete against each other, but do not or may not engage in the game simultaneously or approximately in real time. For example, a user can interact with the game at a first time and his or her opponent (another user) can interact with the game at a later time (e.g., 2-5 minutes later). In contrast, in a synchronous competitive skills based game, two or more players interact and compete with one another, approximately in real time, through interfaces of respective instances of the software application operating on their respective devices. A skills-based game as described herein can be a sports game, an adventure game, a virtual playing card game, a virtual board game, a puzzle game, a racing game, and so forth. The software application can also include various features and functionalities such as enabling users to access, e.g., digital content for entertainment (e.g., a game, music, videos, etc.), business related digital content (e.g., word processing, accounting, spreadsheets, etc.), and other digital content such as news, weather, finance, sports, etc.

In aspects, the end user client application can be a software application in the form of the multicade platform. For example, the multicade platform can be installed natively (e.g., using an app store download) or alternatively launched as a web application that runs within a web browser.

In aspects, instructions for operating software instances (i.e., each of the end user client application instances 114, 116, and 128) on the client devices 110, 112, and 128 can be stored, at least partially, in local memories 118, 120, and 130 included as part of one or more hardware components built within the client devices 110, 112, and 126. Further, operation of the software instances can be controlled by accessing and executing instructions stored within the database 122 and the code repository 124. Specifically, the software instances can access, simultaneously, sequentially, or in a particular predefined order, instructions, digital content, and various other types of data stored in local memories 118, 120 130, the database 122, and/or the code repository 124, to enable users to interact with the software application instances operating on their respective client devices 110, 112, and 126. In aspects, the end user client application instances (e.g., 114, 116, and 128) can be customized for a particular device on which it operates. For example, the end user client application instance (software application instance) can be a version of the software application instance customized for operation, interaction, and display on a smartphone. In aspects, the software application instance can be a part of a software application available for purchase from an iPhone's digital application store, google play digital application store, and so forth. In aspects, the end user client application instance can be another version of the software application accessible from a web browser accessible from and operable on a laptop, a smartphone, a laptop computer, a tablet computer, a smartphone, a desktop or personal computer, game consoles, and other such comparable devices. In aspects, operation of the end user client application instances can involve use of at least some common instructions accessible from the code repository 124. Further, the code repository 124 can include some instructions specific to and designated for enabling operation of each end user client application instance on their respective client devices.

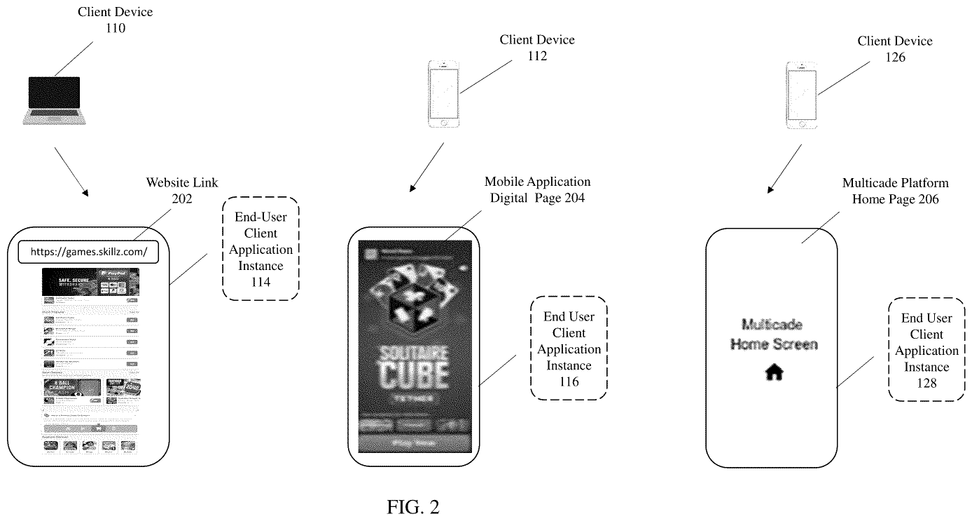

FIG. 2 depicts respective digital representations of different digital pages of end user client application instances 114, 116, and 128, according to some aspects described and illustrated herein. As illustrated, the end user client application instance 114 operating on the client device 110 corresponds to a web application that can be accessed by, e.g., a number of web browsers into which a website link 202 can be input. In contrast, the end user client application instance 116 operating on the client device 112 (e.g., smartphone) corresponds to a smartphone application accessible via, e.g., a digital application store as described above. An example of a mobile application digital page 204 is illustrated in FIG. 2. As another example, the end user client application instance 128 operating on the client device 126 (e.g. smartphone) corresponds to the multicade platform 206 operating on the client device 126. In any case, each end user application instance is interchangeable and device-agnostic, such that the core functionality of each end user application instance can be accessed consistently across laptops, smartphones, and other connected devices.

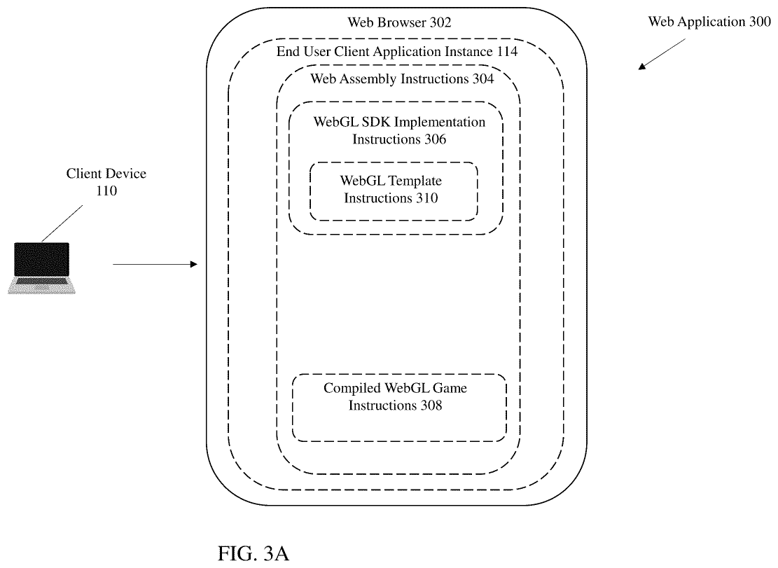

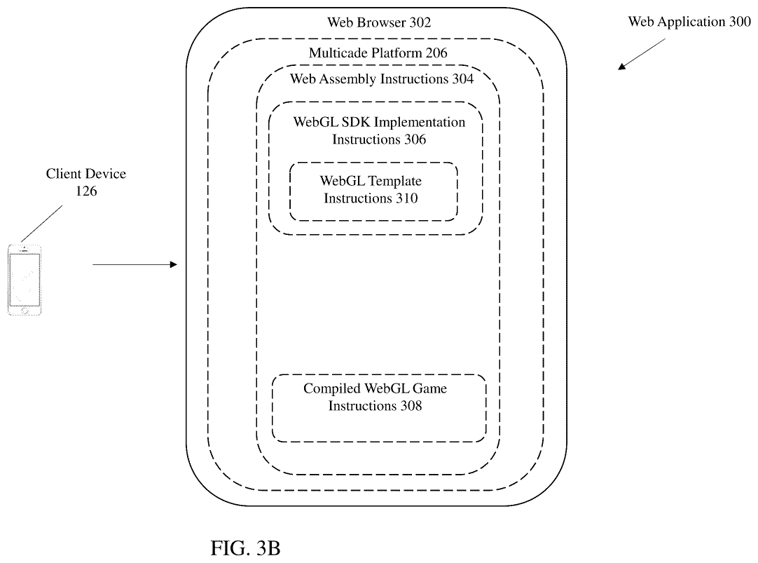

FIG. 3A depicts an example framework of a web application 300 comprising a plurality of digital layers and instructions that enable operation of the end user client application instance 114 on the client device 110, in accordance with some aspects described and illustrated herein. As illustrated, the web application 300 can operate as part of and in association with a web browser 302 accessible via the client device 110. For the end user client application instance 114 to operate on the web browser 302, web assembly instructions 304 are executed. In aspects, these instructions are executed separately or in combination with one or more instructions saved in the database 122 of the back end 102 and executed by the servers 104, 106, and 108. In aspects, the framework of the web application 300 includes the web assembly instructions 304, which includes a web graphics library (WebGL) based software development kit (SDK) implementation instructions 306 and a set of compiled WebGL game instructions 308. In aspects, the WebGL SDK implementation instructions 306 also includes a set of instructions that enable interaction with and use of the WebGL template (i.e. based on execution of WebGL template instructions 310. In aspects, the WebGL template can include instructions that enable communication between (e.g., sharing of data between) aspects of the end user client application instance 114 operating on the client device 110 and the back end 102. In aspects, the instructions of the WebGL template can be in uncompiled form. In aspects, the WebGL SDK implementation instructions 306 is based on a Web Graphics library, which comprises JavaScript API based instructions and algorithms and c-sharp (a.k.a. c#) based instructions and algorithms. At least some of these instructions and algorithms, upon execution, enable rendering and displaying of digital content in the form of interactive 2D and 3D graphics with which users interact. These 2D and 3D graphics can be part of a synchronous or asynchronous game displayed within the end user client application instance 114 accessible via the web browser 302 on the client device 110. In aspects, this can provide the rendering and runtime environment for running WebGL-compatible games, such as Unity or Amazon S3 game builds.

Further, as stated above, the web assembly instructions 304 also include compiled WebGL game instructions 308, at least some of which access one or more algorithms (e.g., function commands, or one or more function-based instructions or algorithms) included within the WebGL SDK implementation instructions 306. In aspects, the WebGL game instructions 308, which in part, enable operation of the end user client application instance 114 (e.g., an instance of a digital game) on the web browser 302 and comprise a set of compiled instructions. In other words, the WebGL game instructions 308, as presented in the web browser 302, can be in the form of machine-readable code or instructions that are more easily executable by the hardware of the client device 110. For example, the compiled WebGL game instructions 308 can be in binary code format, and as such, can be efficiently executable by a data processor of the client device 110. In other aspects, the compiled WebGL game instructions 308 can be in another format (e.g., other than in binary code format) that is in a machine specific or software architecture specific language and cannot be readable or interpretable by a human. Further, the WebGL game instructions 308 can comprise compiled instructions that are compiled on a device that is separate and distinct from the device on which the web browser 302 operates, namely a device that is separate and distinct from the client device 110. Moreover, the source code utilized to generate the compiled instructions are also included as part of this separate and distinct device, and as such, the client device 110 can be prevented from accessing the source code. As such, an advantage of using the compiled WebGL game instructions 308 to control operation of the end user client application instance 114 (e.g., a digital game) is that these instructions can enable a more secure operation of the digital game on the device (e.g., lesser likelihood of gamers altering the instructions to generate fraudulent scores, etc., as these scores cannot be readily readable or interpretable by humans,). Further, in aspects, the WebGL SDK implementation instructions 306 can also include compiled instructions that cannot be readable, interpretable, and easily alterable by gamers.

In some implementations, the end user client application instance can correspond to the multicade platform 206. For example, FIG. 3B depicts a multicade platform 206 that operates in association with the plurality of digital layers and the client device 126. The multicade platform 206 can operate as a modular, browser-executable runtime environment that hosts multiple digital games. For example, the multicade platform 206 can include an application platform that interfaces with a catalog of digital games, including third-party games, server-side rendered games, web application games, etc.

In aspects, the multicade platform 206 can be deployed as part of and in association with the web application 300 and the web browser 302. For example, for the multicade platform 206 to operate on the web browser 302, web assembly instructions 304 are executed. In some instances, the web browser 302 can host an end user client application instance, which can serve as the runtime container for the multicade platform 206. The end user client application instance, serving as the runtime container, can be tailored for the type of client device such that the multicade platform 206 provides a uniform and consistent user experience across various client devices and platforms (e.g., personal computers, laptops, mobile phones, gaming devices, etc.).

In aspects, the multicade platform 206 can interface with a digital game using the web assembly instructions 304, which can include the WebGL SDK implementation instructions 306 and compiled WebGL game instructions 308. For example, in some implementations, the WebGL SDK instructions 306 can expose a set of predefined APIs that allow the multicade platform 206 to integrate with the developer's game code. These APIs can be used for initializing the game environment, passing metadata (e.g., user identification (ID), tournament ID, session token), monitoring to in-game events, and submitting gameplay results.

By integrating the developer's game instance with the multicade platform 206, the platform can provide several technical and commercial advantages. For example, by incorporating the multicade platform in the plurality of digital layers, this restricts users from easily accessing and manipulating the digital game score and outcome by obfuscating the core developer code and score logic. Further, the WebGL template can further abstract the rendering and UI operations, so that score-related events are encapsulated in operations not easily intercepted or altered by external code (e.g., proxy code).

As another advantage, by incorporating a centralized platform that can exchange data (e.g., game data, user data, metadata) with multiple games, the multicade platform 206 can maintain a persistent and secure record of the user's identity, preferences, and performance data across multiple game sessions and titles. This can enable the platform to deliver personalized and tailored feedback to the user, such as contextual overlays (e.g., scoreboards, timers, match status), performance statistics (e.g., score, ranking across multiple games, time spent playing), and other feedback.

Further, the multicade platform 206 can monitor key performance indicators such as game accessed, win/loss ratio, completion time, score deltas, play frequency, or early exit behavior. This data can be captured by the multicade platform 206, which can analyze this data to assess the user's proficiency, engagement level, and gameplay patterns, as well as to identify games most frequently played by the user. For example, based on this analysis, the multicade platform can personalize the user's experience by recommending other games from similar genres or with comparable game play mechanics. Alternative games that may be better fit for the user's skill level, preferred genre, or play style can also be recommended based on the analysis. For instance, if a user frequently plays a particular puzzle game, the platform can suggest other puzzle-based or logic-driven titles. Alternatively or in addition, if a user is consistently underperforming in a fast-paced game, the platform could suggest a more accessible title within the same genre. Conversely, high-performing players may be directed to higher-stakes tournaments, featured competitive events, or other monetization opportunities. In some instances, the platform can provide personalized recommendations, featured tournaments, and game switching options. Together, this approach can improve the user's experience by helping players discover games that better match their skills or preferences. The platform can also improve user retention and acquisition by providing a centralized location for users to experience multiple digital games.

In aspects, the multicade platform can function as a web application instance within the web browser 302 and communicate directly with the WebGL SDK 306 using web assembly instructions 304. In aspects, the multicade platform 206 can exist as a standalone client application that runs directly on the client device 126. In some implementations, the multicade platform 206 can be embedded natively into an application, such as a mobile application.

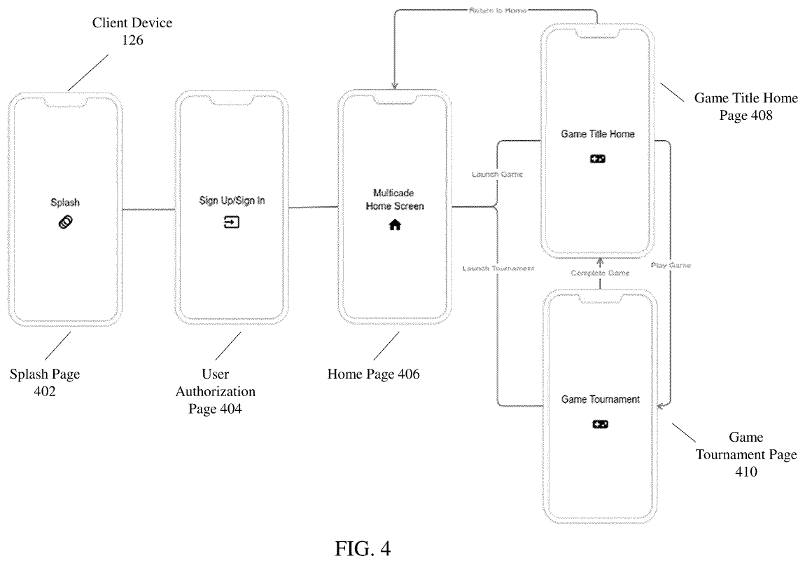

FIG. 4 depicts several example representations of different digital pages of the multicade platform 206. For example, the multicade platform can host a variety of digital games (e.g., arcade games, competitive multiplayer games, single-player experiences) within a unified web application environment. Each game within the multicade can be independently accessed and played using the web application. At 402, the user can access a splash page 402 on the multicade platform 206 operating on the client device 126. The splash page 402 can serve as the initial loading screen presented to users when the multicade platform 206 is launched. In aspects, the multicade platform 206 can initialize additional digital pages, such as the user authorization page 404, the home page 406, or game title home page 408, using the web assembly instructions 304 and the WebGL SDK implementation instructions 306.

At 404, once the user accesses the splash page 402, the platform can provide a user authorization page 404. On this page, the platform can request authorization credentials, (e.g., username and password information) from the user. The user authorization page 404 can prompt the user to log in, register, or connect to the platform using third-party credentials. Once the user inputs their credentials, the authorization information can be securely sent to backend authentication services (e.g., back end 102) to verify the credentials. In aspects, the multicade platform 206 can execute web assembly instructions 304 to interface and authorize the credentials (e.g., interface with database 122 and servers 104, 106, and 108). In aspects, the multicade platform can communicate with backend services through API calls originating from the end user client application instance 128. In aspects, the user authorization page 404 can provide a link or landing page for new users to sign up for the service.

At 406, once the user's credentials are verified, users can access the multicade home page 406. The home page 406 can serve as the central hub for digital content, including game discovery, account information, featured content, and cross-game promotions. This page can leverage the WebGL template instructions 310 to present an interactive user interface, including game lists, search filters, banners, and user-specific recommendations. In aspects, the home page 406 can enable the user to interact with digital content, such as launching a game or launching a tournament. In aspects, the home page 406 can include interactive icons to other pages on the multicade platform 206, such as account settings, game library, leaderboard scores, etc. In aspects, the home page 406 can include icons to additional digital pages, such as landing pages for user deposit accounts, the platform store page, or links to third-party vendor websites.

When a user selects a specific game, the multicade platform 206 can transition to the corresponding game's dedicated title home screen. For example, at 408, the multicade platform 206 can generate an interface using shared elements from the WebGL template instructions 310. This interface can be populated with game-specific assets, metadata, and options (e.g., “Play Now”, “View Leaderboard”, “Settings”, etc.). At this stage, the multicade platform 206 can also load compiled WebGL game instructions 308 to control operation of the digital game. These instructions can make it more difficult for users to fraudulently modify or impact the scores of the digital game because the scores are obfuscated and not readily readable or interpreted. In aspects, the multicade platform 206 can also establish a secure data session with the back end 102 to validate the game session, fetch leaderboard data, or enforce specific anti-fraudulent parameters and requirements.

For games that offer competitive tournament play, users can navigate on the multicade platform 206 to a tournament page associated with a selected title, such as game tournament page 410. The game tournament page 410 can provide real-time tournament data including brackets, entry fees, prize pools, participant status, countdown timers, etc. Similar to the game title page 408, the multicade platform 206 can load compiled WebGL game instructions 308 to control operation of the digital game instance in the tournament. Further, background services can establish a secure data session with the back end 102 to deliver live tournament updates, scores, and notify users of relevant events.

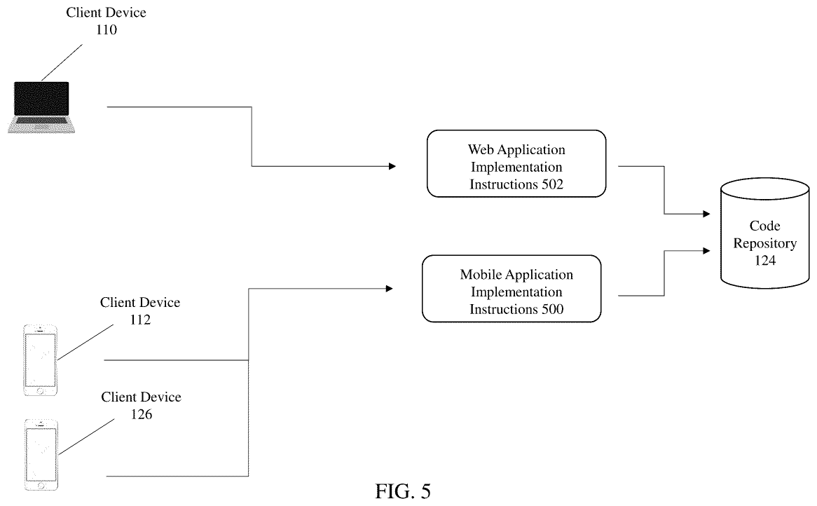

FIG. 5 depicts a step of storing instructions usable for implementation of mobile application implementation instructions 500 and web application implementation instructions 502 in a common memory location such as the code repository 124, according to some aspects described and illustrated herein. As stated, the code repository 124 (e.g., GitHub, and/or other comparable platforms) can include instructions specific to and designated for enabling operation of the end user client application instance 116 on the client device 112 (e.g., mobile application implementation instructions 500) and end user client application instance 128 on the client device 126 (e.g., mobile application implementation instructions 500). The code repository 124 can include additional instructions specific to and designated for enabling operation of the end user client application instance 114 on the client device 110 (e.g., web application implementation instructions 502). In aspects, most of the instructions usable for operating the end user client application instance 114, the end user client application instance 116, and the end user client application instance 128 can be common. An exemplary advantage is that the routing scheme utilized for navigating from one digital page of a digital game to another in the end user client application instances 114, 116, and 128 can be controlled by execution the same code stored in the code repository 124. Use of the common routing scheme can result in a computationally efficient use of hardware resources, e.g., reduced memory usage. When such common code is executed to enable page navigation across hundreds or thousands of gaming instances operating on respective devices, the overall improvement in computational efficiency can be significant, the delays associated with page transitions can be markedly reduced, and the overall user experience is much improved.

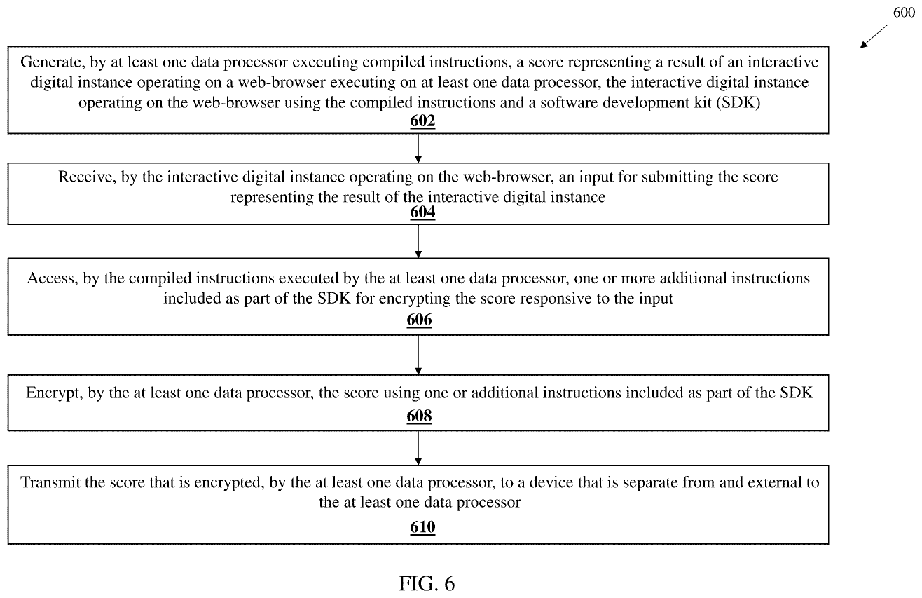

FIG. 6 depicts a flow chart for securely generating data and sharing data among the various devices included as part of the data management system 100 of the present disclosure, according to some aspects described and illustrated herein. The subject matter of FIG. 6 will be described in conjunction with and interchangeably with subject matter depicted in other figures.

At block 602, a score representing a result of an interactive digital instance operating on the web browser 302 executing on at least one data processor can be generated. In some implementations, the interactive digital instance can include a browser-side application. In aspects, as stated above, the interactive digital instance (e.g., the end user client application instance 116) can operate on the web browser 302 using compiled instructions (compiled WebGL game instructions) and a software development kit (WebGL SDK Implementation Instructions 306).

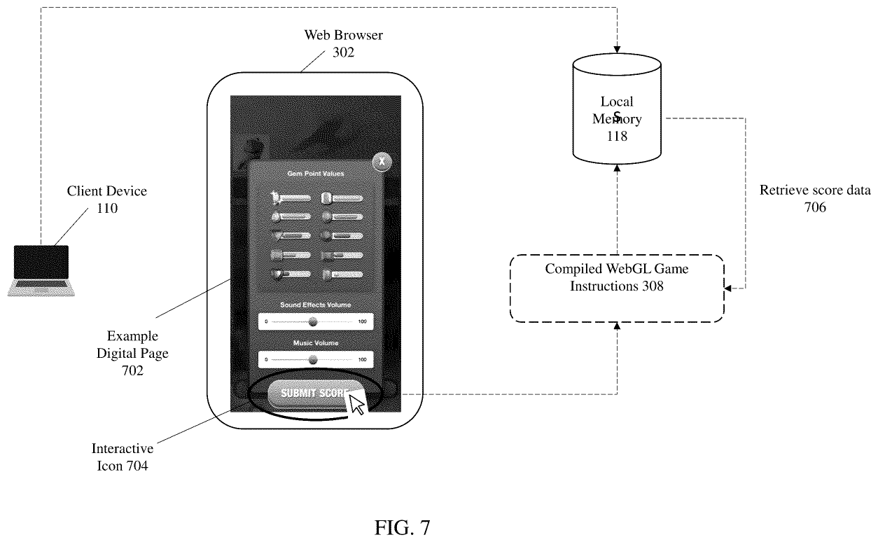

At block 604, an input for submitting the score representing the result of the interactive digital instance can be received by the interactive instance operating on the web-browser. For example, FIG. 7 depicts an example digital page 702 of the end user client application instance 116, according to some aspects described and illustrated herein. As depicted, a user can select an interactive icon 704 displayed on the example digital page 702 in order to initiate a submission of a score. Thereafter, as least some of the web assembly instructions 304 can be executed, automatically and without user intervention, to enable the data management system 100 to securely generate the score according to a predefined process.

At block 606, one or more instructions included as part of the SDK (WebGL SDK Implementation Instructions 306) can be accessed by the compiled instructions (compiled WebGL game instructions) for encrypting the score after generation. In aspects, the encrypted score can be transmitted to the back end 102 (further securing the encrypted score in transit). Furthermore, as a way of preventing falsification or altering of a generated score, the web assembly instructions 304 can significantly inhibit user access to a textual and/or alphanumeric version of the score. Returning to FIG. 7, upon selection of the interactive icon 704, the compiled WebGL game instructions 308 can access one or more instructions included in the WebGL SDK implementation instructions 306 such as, e.g., an encryption algorithm or an encryption function (e.g., Advanced Encryption Standard (AES) algorithm), that performs an encryption operation on the score (e.g., a numeric score) that is generated in block 602 above. It is noted that a textual or alphanumeric version of the generated score may not be accessible by or revealed to the user of the client device 110 on which the end user client application instance 114 operates. Further, as the encryption technique that is utilized can be hidden, manipulating the score by using, e.g., a proxy server, can be prevented.

Instead, upon selection of the interactive icon 704, a score can be generated (e.g., unencrypted data representing the score is generated) and a bitwise shifting operation can be performed on the unencrypted data (e.g., bitwise shifting to the left). Further, a salt or salt hashing operation can be implemented on the unencrypted data. Thereafter, the bitwise shifted unencrypted data on which the salt or salt hashing operating is performed, is stored locally in the local memory 118 of the client device 110. In particular, the score bitwise shifted form can be modified to include a multicharacter string (e.g., a salt) and a hashing algorithm can be implemented on the score including the multi-character string to generate, e.g., a hexadecimal number, another string, etc. The bitwise shifted form of the score, the bitwise shifted score modified to include the multi-character string, and the different multi-character string generated as a result of the hashing algorithm, can all be positioned in association with each other in different columns of a table stored in and accessible from the local memory 118. In aspects, the content of the bitwise shifted score can be accessed using its corresponding multi-character string (salt) and/or the string generated as a result of the hashing operation.

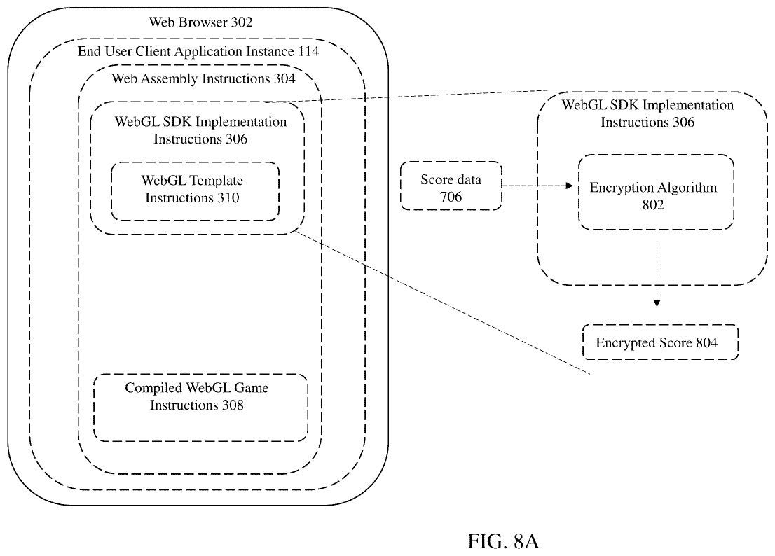

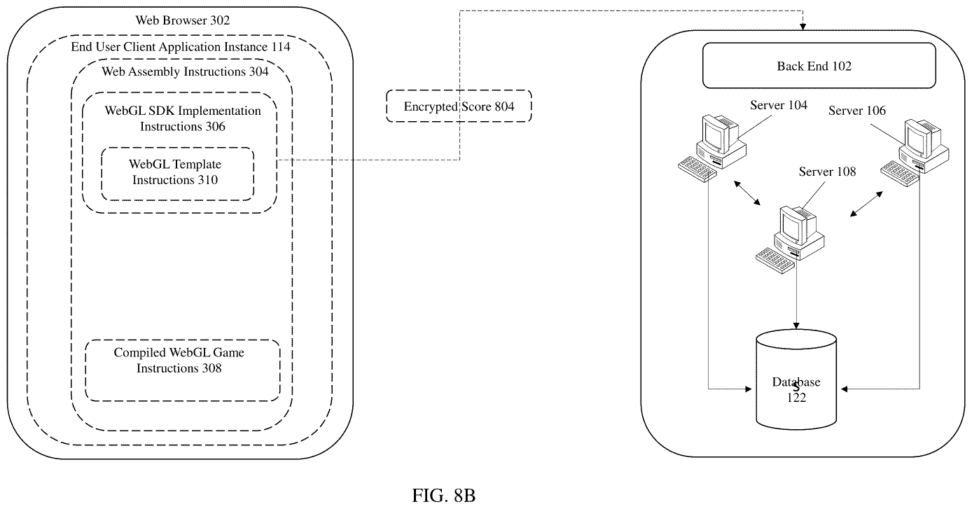

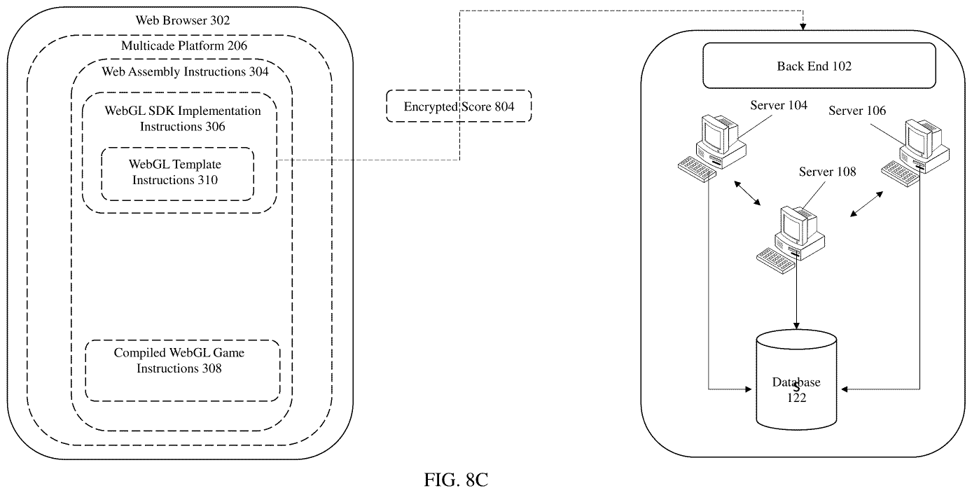

An example implementation for securely accessing the bitwise shifted score is depicted in FIG. 8. In aspects, upon selection of the interactive icon 704, at least some of the compiled WebGL game instructions 308 can be executed and, upon verification of the salt value specific to a particular generated score and/or the string generated as a result of the hashing operation, the bitwise shifted version of the score can be accessed. Thereafter, another bitwise shifting operation can be implemented on the bitwise shifted version of the score in order to access the numeric version of the score (retrieved score data 706). For example, if the score that is generated is stored in local memory 118 as bitwise shifted in a particular direction (e.g., left) then retrieving the score data 706 in unbitshifted form (e.g., original form) can involve implementing a bitwise shifting operation in another direction (e.g., right) and then accessing or verifying the salt value specific to the generated score and/or the string generated as a result of the hashing operation. In aspects, execution of at least some of the compiled WebGL game instructions 308 can result in an implementation of a bitwise shifting operation performing on the bitwise shifted score stored in the local memory 118 in a direction that is opposite to the direction of the stored bitwise shifted score. In this way, the content of the score (in alphanumeric form, numeric form, or text form) can be retrieved from local memory 118 and routed to the WebGL SDK implementation instructions 306 for further processing.

Returning to FIG. 6, at block 608, the one or more additional instructions included as part of the SDK can be utilized by the at least one data processor to encrypt the score. FIGS. 8A, 8B, and 8C detail aspects of the processes implemented to perform one or more encryption operations on the generated score, according to some aspects described and illustrated herein. As depicted in FIG. 8A, the compiled WebGL game instructions 308, upon execution, retrieve the content of the score (in alphanumeric form, numeric form, or text form) from the local memory 118 in the manner described above, and then route the score (in alphanumeric form, numeric form, or text form) such that at least some of WebGL SDK implementation instructions are executed relative to the score in order to encrypt it. For example, an encryption algorithm 802 (an Advanced Encryption Standard (AES) based encryption algorithm) included as part of the WebGL SDK implementation instructions can be implemented on the alphanumeric, numeric, or text version of the score (e.g. unencrypted score) in order to generate an encrypted score 804. In aspects, the AES based encryption algorithm can be an asymmetric encryption algorithm or a symmetric encryption algorithm. The asymmetric encryption algorithm can utilize a public key-private key pairing in which data encrypted with the public key can only be decrypted with the private key. Alternatively, the symmetric encryption algorithm is such that a single key can be utilized for encryption and decryption of information. In aspects, additional data hops or routing of data can be implemented between the web browser 302 and back end 102 in order to make it more difficult for, e.g., a hacker, to reverse engineer and decrypt the encrypted score after it is transmitted by the end user client application instance 114 to the back end 102.

At block 610, the score that is encrypted can be transmitted to a device that is separate from and external to the at least one data processor. Specifically, as shown in FIG. 8B, the encrypted score 804 that is generated in the manner described above can be transmitted, automatically and without user intervention, to the back end 102 for further processing by the servers 104, 106, and 108. In aspects, the encrypted score 804 can be decrypted by the back end 102, further processed by the servers 104, 106, 108, and stored in the database 122. In aspects, the encrypted score 804 can be further secured after it is transmitted by the end user client application instance 114 to the back end 102. For example, additional verification steps can be included prior to the decryption and storage of the encrypted score 804 received by the back end 102. For example, one or more verification processes can be implemented in order to determine or cross check various characteristics of a game binary associated with the end user client application instance 114. Upon one or more of the servers successfully verifying the game binary, the encrypted score 804 can be decrypted and further processed and/or stored in the database 122. In other aspects, the back end 102, upon receiving a message that a user of the end user client application instance 114 has selected the interactive icon 704 (Submit Score), can transmit a session token and embed the session token as part of the web assembly instructions 304. In aspects, some form of verification can be performed in end user client application instance 114, which enables decryption of the encrypted score 804. These verifications can be based on fingerprint tokens generated and transmitted in real time, embedding of a separate salted value that is based on iFrame content specific to the web browser 302 on which the end user client application instance 114 operates, and so forth.

In aspects, the one or more encryption operations can be performed in conjunction with the multicade platform 206. For example, FIG. 8C depicts an example implementation of securely generating data and sharing data using the multicade platform 206. The multicade platform 206 can refer to either a web-based client application operating within a web browser or a native mobile application installed on an iOS or Android device. In some implementations, encryption of the score can be initiated within a WebGL template executing in an iFrame (e.g., in the web-based version of the multicade platform 206), where compiled WebGL game instructions 308 and shared C# code perform an initial encryption operation. The partially encrypted score can then be passed to a higher-level application layer e.g., a browser-side application, which can apply further encryption, verification, and encoding steps before transmitting the score to the back end 102. In aspects, the verification can be based on iFrame content specific to the web browser 302. It should be noted that in native mobile implementations, similar logic can be applied using the shared C# codebase, although the precise mechanisms for initiating and completing the encryption may differ (e.g., not involving iFrames).

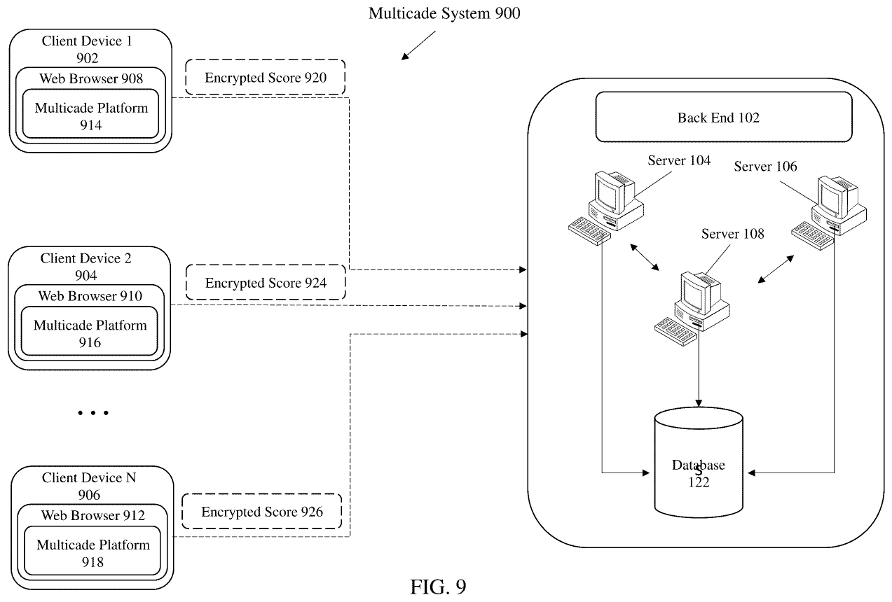

The encrypting operations and data exchange from the data management system 100 and the multicade platform 206 can operate as part of a larger multicade system. For example, FIG. 9 depicts a multicade system 900 that incorporates aspects from FIGS. 8A-8C. As depicted in FIG. 9, the multicade system 900 can include a first client device 902, a second client device 904, an Nth client device 906, and the back end 102. In aspects, the second client device 902 and the Nth client device 906 can be substantially the same as the first client device 902. In aspects, each client device 902-906 can comprise different computing devices. For example, the first client device 902 can comprise a mobile phone, the second client device 904 can comprise a tablet, while the Nth client device 906 can comprise a personal computer. In some implementations, the multicade system 900 includes additional client devices, such as a third client device up to an Nth client device 906, where N can be any suitable number and can vary over time.

The multicade system 900 can facilitate the data exchange between multiple sources, including the client devices 902-906 and the back end 102. The data exchange between each client device and the back end 102 can be performed as previously described herein. For example, each client device 902-906 can generate a respective encrypted score 920-926. Each encrypted score 920-926 can be generated in a manner similar to encrypted score 804 as described above. The back end 102 can receive and perform operations on the encrypted scores 920-926, such as decrypting, validating, and storing the encrypted scores 920-926.

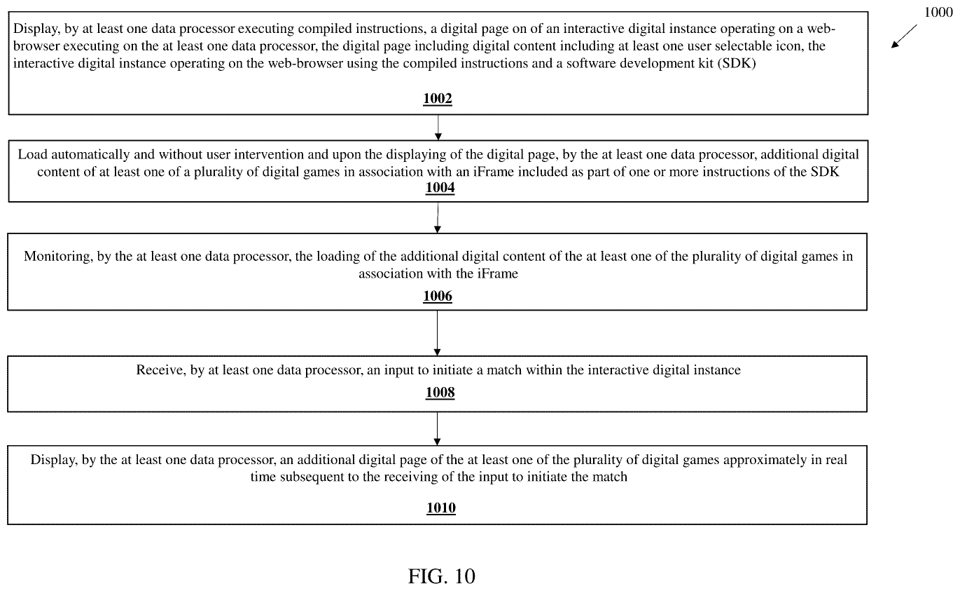

FIG. 10 depicts a flow chart for implementing a process for efficient rendering and displaying of digital content in the end user client application instance 114 operating on the client device 110, according to some aspects described and illustrated herein. The subject matter of FIG. 10 will be described in conjunction with and interchangeably with subject matter depicted in other figures.

At block 1002, a digital page of an interactive digital instance operating on a web-browser executing on the at least one data processor can be displayed. The digital page can include digital content in the form of at least one user selectable icon. In aspects, the interactive digital instance (e.g., end user client application instance 114) operates on the web browser 302 using the web assembly instructions 304 compiled instructions (Compiled WebGL Game Instructions 308) and a software development kit (SDK) (WebGL SDK implementation instructions 306).

At block 1004, additional digital content of at least one of a plurality of digital games in association with an iFrame included as part of one or more instructions of the SDK (WebGL SDK implementation instructions 306) can be loaded, automatically and without user intervention. The loading of additional digital content occurs approximately in real time with (e.g., within a second or a few microseconds) of the display of the digital page of block 1002. The iFrame can be defined as an element (e.g., an instruction in the form of software code) that operates to access and load digital content from a location external to the location of the iFrame in order enable rendering and displaying of the loaded digital content on a particular digital page, e.g., a digital page displayed within the end user client application instance 114.

At block 1006, the loading of the additional digital content of the at least one of the plurality of digital games in association with the iFrame can be monitored. For example, the web assembly instructions 304 can, using the iFrame, determine and progressively track (approximately in real time) an amount of digital content of the at least one of the plurality of digital games that has been loaded, e.g., 10%, 20%, 30%, and so forth. In aspects, the web assembly instructions 304, using the iFrame, can continue loading content if these instructions determine that only 20% of, e.g., a particular digital page, of the at least one of the plurality of digital games has been loaded. In contrast, if the web assembly instructions 304 determine that 100% of the content has been loaded, the web assembly instructions 304 may determine that the digital page is ready for rendering and then display the loaded digital contents on the digital page. In other aspects, if a particular threshold amount of digital content has been loaded that may be less than 100% (e.g., 70%, 80%), the web assembly instructions 304 may nonetheless determine that the digital page is ready for rendering and display the digital content on the digital page. In aspects, the loading of the digital content, using the iFrame includes extracting additional digital content of at least one of the plurality of digital games from, e.g., a content delivery network (CDN), that is different from and external to, e.g., the client device 112 on which the web browser 302 operates.

At block 1008, an input to initiate a match within the interactive digital instance (e.g., a digital game) can be received. In aspects, the input can correspond to moving a cursor over a portion of a digital page of the end user client application instance 114 and selecting a user selectable icon (e.g., interactive icon) that starts a match (e.g., a contest within a digital game as described in the present disclosure). In aspects, the user can select the user selectable icon to start the match. Other ways of selecting the user selectable icon are also contemplated (e.g., interacting with a touch screen display, and so forth).

At block 1010, an additional digital page of the at least one of the plurality of digital games can be displayed in, e.g., the end user client application instance 114, approximately in real time, subsequent to the receiving of the input to initiate the match. In aspects, upon selecting a user selectable icon to initiate the match, another digital page (one on which digital content of the match) is displayed approximately instantaneously. In other words, due to the implementation of the steps described in blocks 1002 to 1010, the digital page can be displayed approximately in real time (e.g., within fractions of a second or a few microseconds) without displaying, e.g., a loading page, a buffering page, or any other comparable digital page, to a user. Further, the digital page that is displayed can include at least some of the additional digital content loaded from at least one of the plurality of digital games from, e.g., a content delivery network (CDN), that is different from and external to, e.g., the client device 112 on which the web browser 302 operates.

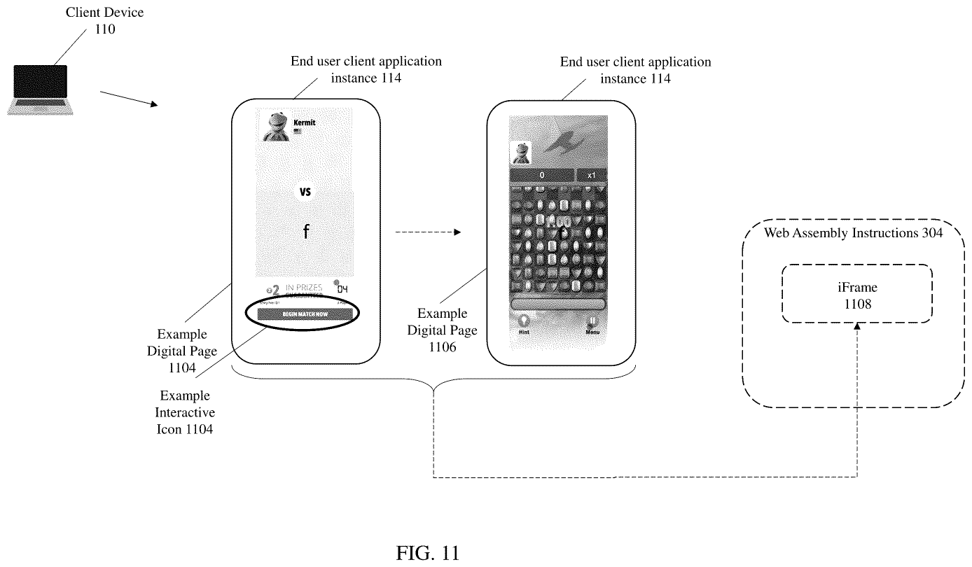

FIG. 11 depicts a use case of the implementation of the process described above and illustrated in FIG. 10. Specifically, in FIG. 11, an example digital page 1102 is output as part of the end user client application instance 114 that includes various types of digital content, including an example interactive icon 1104. Upon selection of the example interactive icon 1104, implementation of the steps described in blocks 1002-1010 results in the display of example digital page 1106 approximately in real time, e.g., within a fraction of a second or within a few microseconds. Additionally, as stated above, the display of the example digital page 1106 occurs without outputting of e.g., a loading page, a buffering page, or any other comparable digital page, to a user. Further, as stated above, the loading of digital content of the example digital page 1106 is monitored based on execution of the web assembly instructions 304 (which includes iFrame 1108), as described above with respect to block 1006.

In some implementations, the process described above and illustrated in FIGS. 10 and 11 can be implemented in the multicade system 800. For example, the multicade platform 206 can leverage the automatic loading and monitoring of the digital content to enable fast and seamless transitions between interface components and game environments. The multicade platform 206 can preload and render the digital pages without the need for traditional loading screens, buffering pages, or user-perceived delays. For example, upon entering the multicade splash page 402, the multicade platform 206 can preload and render the user authorization page 404. Upon entering the user authorization page 404, the platform can preload and render the home page 406. As another example, upon reaching the multicade home page 406, several high-traffic or frequency accessed subpages (e.g., the games tab, account overview tab, leaderboard/tournament view, etc.) can be loaded and rendered in association with an iFrame. In such implementations, the iFrame can be rendered by the browser-side application, which loads into the iFrame a static website containing the compiled webGL template. The static site can include both the game instructions (e.g., Unity-based game instruction) and WebGL template code into which game-specific logic and assets have been embedded. When a user navigates to one of these tabs, the content can appear to load instantly. This approach can reduce the computational overhead and perceived lag from loading and rendering each tab upon user input, such as when a user quickly switches and navigates between multiple tabs. As such, the iFrame instances can maintain active sessions for each tab, so when a user interacts with the tab, this provides a smooth, native-app like experience within the web browser.

Further, this approach can support preloading game instances. For example, when a user navigates to a digital game's landing page, the compiled WebGL game instructions can begin loading an iFrame that hosts the static website described above. In such cases, while the user is on the landing page (e.g., reviewing tournament details, reading game rules, or adjusting settings), the game is already initialized within the iFrame. Then, when the user clicks “Play” or engages with the game instance, the game is already initialized, allowing for near-instantaneous transition into gameplay. This can minimize drop-off due to perceived latency and enhance the overall session continuity.

Additionally, by monitoring the loading of digital content in association with an iFrame, the multicade platform 206 can detach sluggish or vulnerable digital game instances from the platform. For example, each iFrame can isolate each digital game using its own WebGL SDK implementation instructions 306, ensuring that faults or performance issues in one module (e.g., a specific game instance or UI panel) does not disrupt the multicade platform 206. In aspects, the multicade platform 206 can switch or transition between the digital content associated with different iFrames to allow the user to quickly switch between active tabs that are slow or sluggish. In aspects, this transition can be completed automatically or by user input. In aspects, the platform can reboot or restart the sluggish instances running on an iFrame while the user is on another page.

Further, this approach can provide additional security, particularly in the context of fraud protection and score integrity. Because each game is executed within its own sandboxed iFrame environment, the multicade platform can enforce strict boundaries between the core application logic and the game execution code. This obfuscation layer can make it more difficult for users to fraudulently modify or impact the score or outcome of a gaming session. Further, this approach can implement a set of encryption techniques to prevent access to the content of a generated score (e.g. the numeric version of the score).

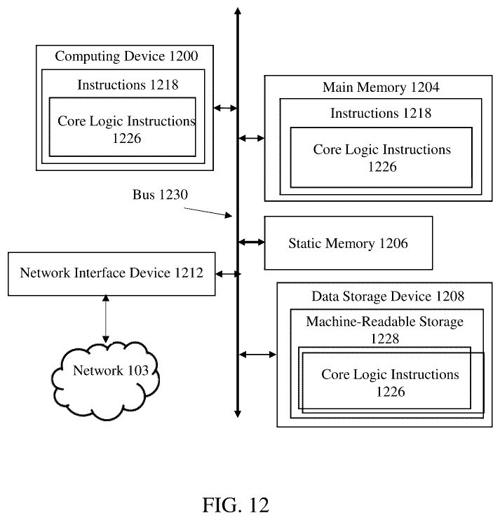

FIG. 12 is a block diagram of an example computing device 1200 that may perform one or more of the operations described herein, in accordance with the present aspects. The computing device 1200 can correspond to the client devices 110, 112, and 126. The computing device 1200 may be connected to other computing devices in a LAN, an intranet, an extranet, and/or the Internet. The computing device 1200 may operate in the capacity of a server machine in client-server network environment or in the capacity of a client in a peer-to-peer network environment. The computing device 1200 may be provided by a personal computer (PC), a set-top box (STB), a server, a network router, switch or bridge, or any machine capable of executing a set of instructions (sequential or otherwise) that specify actions to be taken by that machine. Further, while only a single computing device 1200 is illustrated, the term “computing device” shall also be taken to include any collection of computing devices that individually or jointly execute a set (or multiple sets) of instructions to perform the methods discussed herein.

The example computing device 1200 may include a computer processing device (e.g., a general purpose processor, ASIC, etc.), a main memory 1204, a static memory 1206 (e.g., flash memory or the like), and a data storage device 1208, which may communicate with each other via a bus 1230. The computer processing device 1202 may be provided by one or more general-purpose processing devices such as a microprocessor, central processing unit, or the like. In an illustrative example, computer processing device 1202 may comprise a complex instruction set computing (CISC) microprocessor, reduced instruction set computing (RISC) microprocessor, very long instruction word (VLIW) microprocessor, or a processor implementing other instruction sets or processors implementing a combination of instruction sets. The computer processing device 1202 may also comprise one or more special-purpose processing devices, such as an application specific integrated circuit (ASIC), a field programmable gate array (FPGA), a digital signal processor (DSP), network processor, or the like. The computer processing device 1202 may be configured to execute the operations described herein, in accordance with one or more aspects of the present disclosure, for performing the operations and steps discussed herein.

The computing device 1200 may further include a network interface device 1212, which may communicate with a network 1214. The data storage device 1208 may include a machine-readable storage medium 1228 on which may be stored one or more sets of instructions, e.g., instructions for carrying out the operations described herein, in accordance with one or more aspects of the present disclosure. Instructions 1218 implementing core logic instructions 1226 may also reside, completely or at least partially, within main memory 1204 and/or within computer processing device 1202 during execution thereof by the computing device 1200, main memory 1204 and computer processing device 1202 also constituting computer-readable media. The instructions may further be transmitted or received over the network 1214 via the network interface device 1212.

While machine-readable storage medium 1228 is shown in an illustrative example to be a single medium, the term “computer-readable storage medium” should be taken to include a single medium or multiple media (e.g., a centralized or distributed database and/or associated caches and servers) that store the one or more sets of instructions. The term “computer-readable storage medium” shall also be taken to include any medium that is capable of storing, encoding or carrying a set of instructions for execution by the machine and that cause the machine to perform the methods described herein. The term “computer-readable storage medium” shall accordingly be taken to include, but not be limited to, solid-state memories, optical media, magnetic media, and the like.

The subject matter described herein provides many technical advantages. For example, some implementations of the present subject matter can improve the efficiency and processing capabilities of computer hardware resources (e.g., computer processing and memory) to identify matches by supporting and providing substantially faster matching times, particularly for client applications with large numbers of users (e.g., hundreds of thousands, millions, tens of millions, etc. of users). For example, some implementations of the present subject matter can more efficiently handle large numbers of users enqueuing and identifying matches in a plurality of templates at the same time. By improving the matching speed and efficiency for client applications with large numbers of users, computer hardware resources can be freed up more quickly and used for other tasks and processes, resulting in a significant improvement in computer resource utilization. In addition, the described use of complied WebGL game instructions and SDK layers can facilitate secure and tamper-resistant score generation and transmission, which enhances data integrity without requiring kernel-level drivers or intrusive anti-cheat software. Further, the digital content can be preloaded through the use of embedded iFrames and CDNs, reducing perceived latency and improving the responsiveness of the user interface.

Aspects of the subject matter and the operations described in this disclosure can be implemented in digital electronic circuitry, or in computer software, firmware, or hardware, including the structures disclosed in this disclosure and their structural equivalents, or in combinations of one or more of them. Aspects of the subject matter described in this disclosure can be implemented as one or more computer programs, i.e., one or more modules of computer program instructions, encoded on computer storage medium for execution by, or to control the operation of, data processing apparatus. Alternatively, or in addition, the program instructions can be encoded on an artificially generated propagated signal, e.g., a machine-generated electrical, optical, or electromagnetic signal that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially generated propagated signal. The computer storage medium can also be, or be included in, one or more separate physical components or media (e.g., multiple CDs, disks, or other storage devices).

The operations described in this disclosure can be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer processing device, a computer, a system on a chip, or multiple ones, or combinations, of the foregoing. A computer processing device may include one or more processors which can include special purpose logic circuitry, e.g., an FPGA (field programmable gate array) or an ASIC (application specific integrated circuit), a central processing unit (CPU), a multi-core processor, etc. The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative, procedural, or functional languages, and it can be deployed in any form, including as a standalone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language resource), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this disclosure can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic disks, magneto optical disks, optical disks, solid state drives, or the like. However, a computer need not have such devices. Moreover, a computer can be embedded in another device, e.g., a smart phone, a mobile audio or media player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including, by way of example, semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, aspects of the subject matter described in this specification can be implemented on a computer having a display device, e.g., a CRT (cathode ray tube), LCD (liquid crystal display) monitor or the like, for displaying information to the user and a keyboard and a pointing device, e.g., a mouse, a trackball, a touchpad, a stylus, or the like, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending resources to and receiving resources from a device that is used by the user; for example, by sending web pages to a web browser on a user's client device in response to requests received from the web browser.

Aspects of the subject matter described in this disclosure can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this disclosure, or any combination of one or more such back end, middleware, or front end components. The components of the system can be interconnected by any form or medium of digital data communication, e.g., a communication network. Examples of communication networks include a local area network (“LAN”) and a wide area network (“WAN”), an inter-network (e.g., the Internet), peer-to-peer networks (e.g., ad hoc peer-to-peer networks), and the like.

The computing system can include clients and servers. A client and server are generally remote from each other and typically interact through a communication network. The relationship of client and server arises by virtue of computer programs running on the respective computers and having a client-server relationship to each other. In some aspects, a server transmits data (e.g., an HTML page) to a client device (e.g., for purposes of displaying data to and receiving user input from a user interacting with the client device). Data generated at the client device (e.g., a result of the user interaction) can be received from the client device at the server.

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

Reference throughout this disclosure to “one aspect” or “an aspect” means that a particular feature, structure, or characteristic described in connection with the aspects included in at least one aspect. Thus, the appearances of the phrase “in one aspect” or “in an aspect” in various places throughout this disclosure are not necessarily all referring to the same aspect. In addition, the term “or” is intended to mean an inclusive “or” rather than an exclusive “or.”

While this disclosure contains many specific implementation details, these should not be construed as limitations on the scope of any subject matters or of what may be claimed, but rather as descriptions of features specific to particular aspect of particular subject matters. Certain features that are described in this disclosure in the context of separate aspects can also be implemented in combination in a single aspect. Conversely, various features that are described in the context of a single aspect can also be implemented in multiple aspects separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the aspects described above should not be understood as requiring such separation in all aspects, and it should be understood that the described program components and systems can generally be integrated together in a single software product or packaged into multiple software products.

Thus, particular aspects of the subject matter have been described. Other aspects are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous. The above description of illustrated implementations of the subject matter is not intended to be exhaustive or to limit the subject matter to the precise forms disclosed. While specific implementations of, and examples for, the subject matter are described herein for illustrative purposes, various equivalent modifications are possible within the scope of the subject matter, as those skilled in the relevant art will recognize. The words “example” or “exemplary” are used herein to mean serving as an example, instance, or illustration. Any aspect or design described herein as “example” or “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or”. That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from context to be directed to a singular form. Moreover, use of the term “an aspect” or “one aspect” or “an implementation” or “one implementation” throughout is not intended to mean the same aspect or implementation unless described as such. Furthermore, the terms “first,” “second,” “third,” “fourth,” etc. as used herein are meant as labels to distinguish among different elements and may not necessarily have an ordinal meaning according to their numerical designation.

In the foregoing description, aspects and aspects of the present disclosure have been described with reference to numerous specific details that can vary from implementation to implementation. Accordingly, the description and drawings are to be regarded in an illustrative rather than a restrictive sense. The sole and exclusive indicator of the scope of the subject matter, and what is intended by the applicants to be the scope of the subject matter, is the literal and equivalent scope of the set of claims that issue from this application, in the specific form in which such claims issue, including any subsequent correction. Any definitions expressly set forth herein for terms contained in such claims shall govern the meaning of such terms as used in the claims. In addition, when we use the term “further comprising,” in the foregoing description or following claims, what follows this phrase can be an additional step or entity, or a sub-step/sub-entity of a previously-recited step or entity.

What is claimed is:

1. A method comprising:
generating, by at least one data processor executing compiled instructions, a score representing a result of an interactive digital instance operating on a web-browser executing on the at least one data processor, the interactive digital instance operating on the web-browser using the compiled instructions and a software development kit (SDK);
receiving, by the interactive digital instance operating on the web-browser, an input for submitting the score representing the result of the interactive digital instance;
accessing, by the at least one data processor, one or more additional instructions included as part of the SDK for encrypting the score responsive to the input;
encrypting, by the at least one data processor, the score using the one or more additional instructions, wherein the score is encrypted using a bitwise shifting operation in a first direction on unencrypted data representing the score; and
transmitting the encrypted score, by the at least one data processor, to a device that is separate from and external to the at least one data processor.

2. The method of claim 1, wherein implementation of a process for generating the compiled instructions occurs in the device that is separate from and external to the at least one data processor.

3. The method of claim 1, wherein the receiving of the input for submitting the score comprises selecting an interactive icon output on a digital page of the interactive digital instance operating on the web-browser.

4. The method of claim 1, wherein the encrypting of the score is based on Advanced Encryption Standard (AES) algorithm.

5. The method of claim 1, further comprising:
implementing, by the at least one data processor, a salt hashing operation on the unencrypted data upon which the bitwise shifting operation is performed; and
storing in memory, by the at least one data processor, the unencrypted data upon which the bitwise shifting operation is performed and the salt hashing operation is implemented.

6. The method of claim 5, wherein the encrypting of the score using the one or additional instructions included as part of the SDK comprises:
performing, by the at least one data processor, an additional bitwise shifting operation on the unencrypted data in a second direction; and
retrieving, by the at least one data processor, the unencrypted data.

7. The method of claim 6, further comprising executing, by the compiled instructions, an asymmetric encryption algorithm represented by the one or more additional instructions of the SDK on the unencrypted data that is extracted.

8. The method of claim 6, further comprising executing, by the compiled instructions, a symmetric encryption algorithm represented by the one or more additional instructions of the SDK on the unencrypted data that is extracted.

9. The method of claim 1, wherein the interactive digital instance corresponds to a digital game.

10. The method of claim 9, wherein the score includes data corresponding to a result of a digital gameplay session.

11. A system comprising:
at least one data processor;
memory storing instructions which, when executed by the at least one data processor, causes the at least one data processor to perform operations comprising:
generating a score representing a result of an interactive digital instance operating on a web-browser, the interactive digital instance operating on the web-browser using the compiled instructions and a software development kit (SDK);
receiving an input for submitting the score representing the result of the interactive digital instance;
accessing one or more additional instructions included as part of the SDK for encrypting the score responsive to the input;
encrypting the score using the one or more additional instructions, wherein the score is encrypted using a bitwise shifting operation in a first direction on unencrypted data representing the score; and
transmitting the encrypted score to a device that is separate from and external to the at least one data processor.

12. The system of claim 11, wherein implementation of a process for generating the compiled instructions occurs in the device that is separate from and external to the at least one data processor.

13. The system of claim 11, wherein the receiving of the input for submitting the score comprises selecting an interactive icon output on a digital page of the interactive digital instance operating on the web-browser.

14. The system of claim 11, wherein the encrypting of the score is based on Advanced Encryption Standard (AES) algorithm.

15. The system of claim 11, further comprising:
implementing a salt hashing operation on the unencrypted data upon which the bitwise shifting operation is performed; and
storing in memory the unencrypted data upon which the bitwise shifting operation is performed and the salt hashing operation is implemented.

16. The system of claim 15, wherein the encrypting of the score using the one or additional instructions included as part of the SDK comprises:
performing an additional bitwise shifting operation on the unencrypted data in a second direction; and
retrieving the unencrypted data.

17. The system of claim 16, further comprising executing an asymmetric encryption algorithm represented by the one or more additional instructions of the SDK on the unencrypted data that is extracted.

18. The system of claim 16, further comprising executing a symmetric encryption algorithm represented by the one or more additional instructions of the SDK on the unencrypted data that is extracted.

19. The system of claim 11, wherein the score includes data corresponding to a result of a digital gameplay session.

20. A non-transitory computer program product storing instructions, which when executed by at least one data processor of at least one computing system, cause the at least one data processor to perform operations comprising:
generating a score representing a result of an interactive digital instance operating on a web-browser, the interactive digital instance operating on the web-browser using the compiled instructions and a software development kit (SDK);
receiving an input for submitting the score representing the result of the interactive digital instance;
accessing one or more additional instructions included as part of the SDK for encrypting the score responsive to the input;
encrypting the score using the one or more additional instructions, wherein the score is encrypted using a bitwise shifting operation in a first direction on unencrypted data representing the score; and
transmitting the encrypted score to a device that is separate from and external to the at least one data processor.

21. A method comprising:
displaying, by at least one data processor executing compiled instructions, a digital page of an interactive digital instance operating on a web-browser executing on the at least one data processor, the digital page including digital content including at least one user selectable icon, the interactive digital instance operating on the web-browser using the compiled instructions and a software development kit (SDK);
loading automatically upon the displaying of the digital page, by the at least one data processor, additional digital content of at least one of a plurality of digital games in association with an iFrame included as part of one or more instructions of the SDK;
monitoring, by the at least one data processor, the loading of the additional digital content of the at least one of the plurality of digital games in association with the iFrame;
receiving, by the at least one data processor, a command to initiate a match within the interactive digital instance, the command generated by a user interaction with the interactive digital instance; and
displaying, by the at least one data processor, an additional digital page of the at least one of the plurality of digital games approximately in real time subsequent to the receiving of the input to initiate the match.

22. The method of claim 21, wherein the interactive digital instance corresponds to a digital game operating on the web-browser executing on the at least one data processor.

23. The method of claim 21, wherein the receiving of the input to initiate the match within the interactive digital instance includes selecting an interactive icon for starting the match between two or more users of the interactive digital instance.

24. The method of claim 21, wherein implementation of a process for generating the compiled instructions occurs in an additional device that is separate from and external to the at least one data processor.

25. The method of claim 21, wherein the loading of the additional digital content of the at least one of the plurality of digital games in association with the iFrame comprising extracting the additional digital content of the at least one of the plurality of digital games from a content delivery network (CDN).

26. The method of claim 21, wherein the additional digital page of the at least one of the plurality of digital games including at least some of the additional digital content of the at least one of the plurality of digital games.

27. The method of claim 21, wherein the at least one data processor maintains an active session for each digital page.

28. The method of claim 27, further comprising:
monitoring the performance of the active session on each digital page; and
automatically transition to displaying the digital page upon detecting a decrease in the performance of the active session on the additional digital page.

29. The method of claim 28, further comprising restarting the active session on the additional digital page while displaying the digital page.

30. A system comprising:
at least one data processor included of a computing device;
memory storing instructions which, when executed by the at least one data processor, causes the at least one data processor to perform operations comprising:
displaying a digital page of an interactive digital instance operating on a web-browser, the digital page including digital content including at least one user selectable icon, the interactive digital instance operating on the web-browser using the compiled instructions and a software development kit (SDK);
loading automatically upon the displaying of the digital page, additional digital content of at least one of a plurality of digital games in association with an iFrame included as part of one or more instructions of the SDK;
monitoring the loading of the additional digital content of the at least one of the plurality of digital games in association with the iFrame;
receiving a command to initiate a match within the interactive digital instance, the command generated by a user interaction with the interactive digital instance; and
displaying an additional digital page of the at least one of the plurality of digital games approximately in real time subsequent to the receiving of the input to initiate the match.

31. The system of claim 30, wherein the interactive digital instance corresponds to a digital game operating on the web-browser.

32. The system of claim 30, wherein the receiving of the input to initiate the match within the interactive digital instance includes selecting an interactive icon for starting the match between two or more users of the interactive digital instance.

33. The system of claim 30, wherein implementation of a process for generating the compiled instructions occurs in an additional device that is separate from and external to the at least one data processor.

34. The system of claim 30, wherein the loading of the additional digital content of the at least one of the plurality of digital games in association with the iFrame comprising extracting the additional digital content of the at least one of the plurality of digital games from a content delivery network (CDN).

35. The system of claim 30, wherein the additional digital page of the at least one of the plurality of digital games including at least some of the additional digital content of the at least one of the plurality of digital games.

36. The system of claim 30, wherein the at least one data processor maintains an active session for each digital page.

37. The system of claim 36, further comprising:
monitoring the performance of the active session on each digital page; and
automatically transition to displaying the digital page upon detecting a decrease in the performance of the active session on the additional digital page.

38. The system of claim 37, further comprising restarting the active session on the additional digital page while displaying the digital page.

39. A non-transitory computer program product storing instructions, which when executed by at least one data processor of at least one computing system, cause the at least one data processor to perform operations comprising:
displaying a digital page of an interactive digital instance operating on a web-browser, the digital page including digital content including at least one user selectable icon, the interactive digital instance operating on the web-browser using the compiled instructions and a software development kit (SDK);
loading automatically upon the displaying of the digital page, additional digital content of at least one of a plurality of digital games in association with an iFrame included as part of one or more instructions of the SDK;
monitoring the loading of the additional digital content of the at least one of the plurality of digital games in association with the iFrame;
receiving a command to initiate a match within the interactive digital instance, the command generated by a user interaction with the interactive digital instance; and
displaying an additional digital page of the at least one of the plurality of digital games approximately in real time subsequent to the receiving of the input to initiate the match.

40. The non-transitory computer program product of claim 39, wherein the interactive digital instance corresponds to a digital game operating on the web-browser.
